(19) United States
(12) Patent Application Publication
(10) Pub. No.: US 2012/0022950 A1
(43) Pub. Date: Jan. 26, 2012

(54) Systems and Methods for Targeted Advertising in Voicemail to Text Systems

(75) Inventors: Mazin Gilbert, Warren, NJ (US); Narendra K. Gupta, Dayton, NJ (US); Dan Melamed, New York, NY (US)

(73) Assignee: AT&T INTELLECTUAL PROPERTY I, L.P., Reno, NV (US)

(21) Appl. No.: 12/843,836

(22) Filed: Jul. 26, 2010

(51) Int. Cl. G06Q 30/00; G06F 17/27; H04M 11/00

(52) U.S. Cl. 705/14.66; 379/88.14; 704/9; 705/14.69; 705/14.4

(57) ABSTRACT

Systems and methods are provided for a voice message to text system supporting targeted advertisements. Voice messages received from users are converted to raw text messages that are normalized to insert proper punctuation and extract entity information. The normalized text and entity information are processed to extract concepts, such as critical phrases, from the normalized text. Extracted concepts are then matched to advertisements on an advertisement database having user selection criteria. Advertisements having selection criteria matching the extracted concepts are transmitted to the users, and the advertisers that placed the advertisements are charged fees for the advertisements. User profile information and user context information can additionally be used to select advertisements for transmission to users.

### FIELD OF THE TECHNOLOGY

At least some embodiments disclosed herein relate to voice-to-text systems in general, and more particularly, but not limited to, targeted advertising in voice-to-text systems.

### BACKGROUND

Numerous new business and technology drivers have opened the way for speech recognition and natural language technologies to become vital for both consumer and enterprise businesses. Cloud computing, 3G/4G LTE, faster computing, cheaper storage, standardized APIs, and adoption of smart phones with large screens have been instrumental drivers for the recent surge in the use of cost effective speech technologies.

One application for speech and language technologies that has become vital in today's world is visual voicemail to text; i.e., the ability to convert a spoken voice message into a visual and readable text message. Although obtaining robust and high accuracy voicemail to text remains a challenge, many companies including AT&T and Google have rolled out applications that are either fully automated or semi-automated (having human transcribers in the loop).

Most voicemail to text systems today attempt to apply very large vocabulary speech recognition to convert spoken words into text. The challenges are obtaining high precision, and identifying natural language approaches for post processing the text to provide a readable version of the message. Natural language approaches include inserting punctuations in the appropriate places, chunking and normalizing the text, and highlighting high confidence phrases and important attributes such as names and phone numbers.

Adoption of voicemail to text systems largely depends on the subscription cost. Free voicemail to text systems are mostly automated but have very poor performance, while subscription-based voicemail to text systems tend to have higher accuracy but include humans in the loop.

### BRIEF DESCRIPTION OF THE DRAWINGS

The embodiments are illustrated by way of example and not limitation in the figures of the accompanying drawings in which like references indicate similar elements.

FIG. 1 shows an example of a dialog between two persons mediated, at least in part, using elements of a voice-to-text system supporting targeted advertising.

FIG. 2 shows an example of a high-level overview of a network supporting a voice-to-text system with targeted advertising.

FIG. 3 shows a block diagram of a data processing system which can be used in various embodiments of a voice-to-text system.

FIG. 4 illustrates an overview of a computer-implemented process for targeted advertising in voice-to-text systems

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, the disclosed systems and methods provide a system that transcribes voice messages to text and mines the contents of such messages to automatically identify targeted advertisements and coupons. Thus, voicemail to text applications can be a free service with monetization through advertising and coupons.

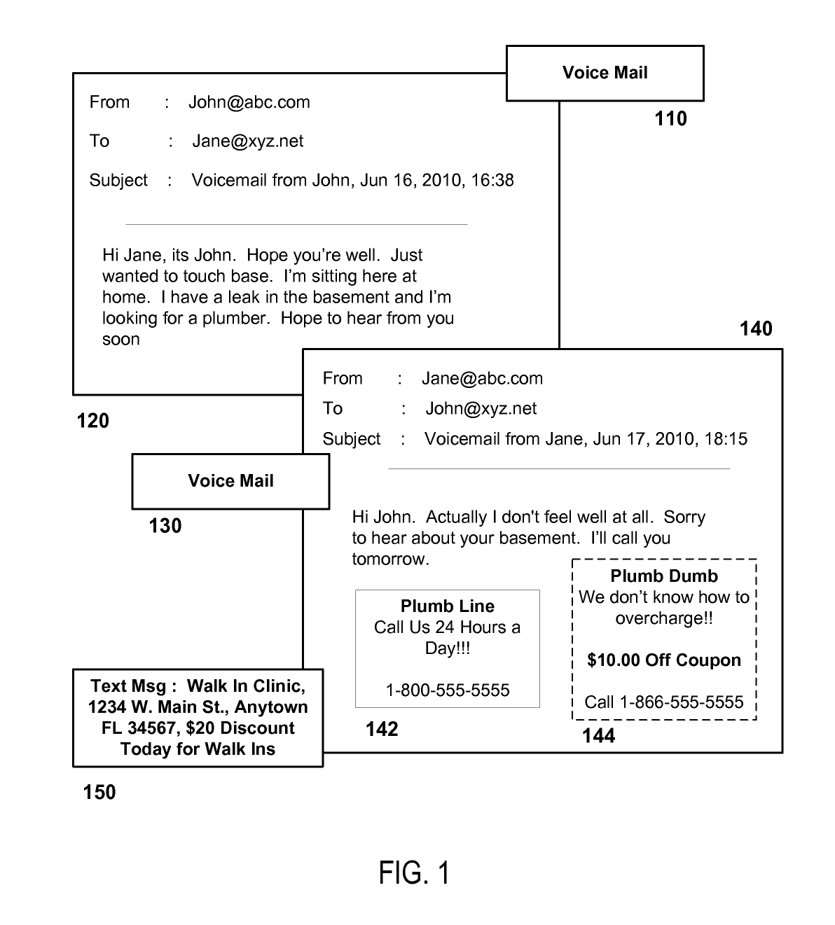

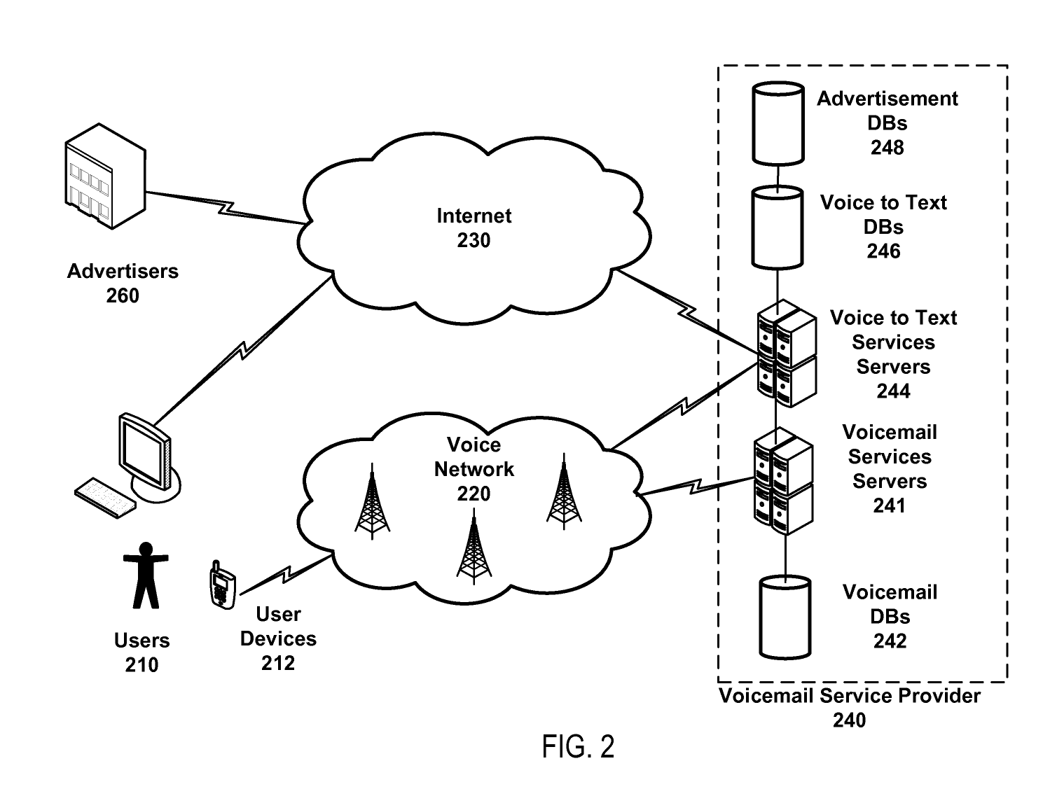

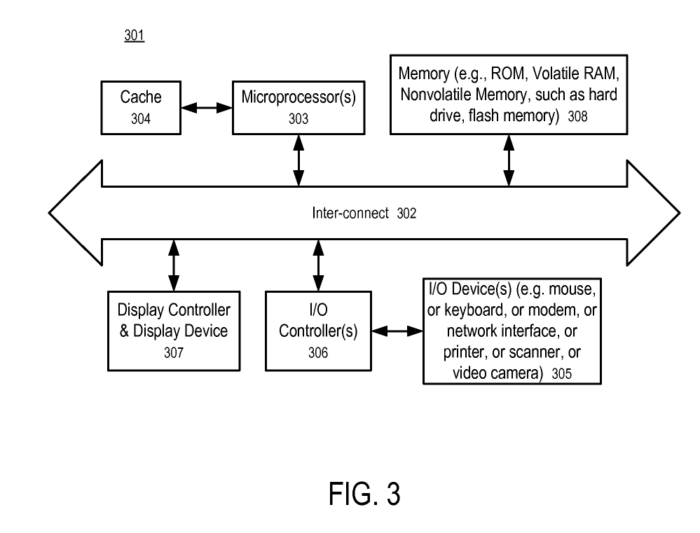

FIG. 1 shows an example of a dialog between two persons mediated, at least in part, using elements of a voice-to-text system supporting targeted advertising. In one embodiment, one or more processes running on voice-to-text services servers or voicemail services servers, as shown and described in more detail below with respect to FIGS. 2 and 3, provide the functions of the system.

In the first action in the dialog, John leaves a voice message 110 for Jane mentioning that he has a leak in his basement and is looking for a plumber. Any voicemail or voice message system now known or later to be developed could provide such voice messaging capabilities and could be implemented within any voice network such as, for example, a landline based network, an IP telephony based network, or a mobile network such as a cellular network.

One or more processes running on the voice-to-text services server transcribe the voicemail to a text message using voice recognition and natural language processing techniques such as those discussed in greater detail below. The server then sends the text message as an email 120 from or on behalf of John to Jane. Alternatively, the server could address the email 120 as originating from the voice-to-text system (e.g. from voicemail@voice.net). While the illustrated embodiment shows an email 120, a voice-to-text services server could send the generated text to Jane using any form of text-based electronic communications, such as, for example, text messages, blog posts, microblog posts (e.g. Twitter) or as messages on a social networking site. In one embodiment, the voice-to-text services server could send messages using more than one form of text based communication.

In one embodiment, both John and Jane are known to the voice-to-text system and have user profiles set up on the system. Such user profiles could contain, for example, user contact information, user demographic information, user preferences, user interests and/or user social networking information. User contact information could specify, for example, email addresses, text message addresses, blog addresses and/or social networking or microblogging user IDs. User preferences could specify preferred modes of communication, and/or other users from which the user wishes to receive voice-to-text messages. User interests could include topics, brands, products, goods and services in which the user is interested.

In one embodiment, only the recipient of a voice message is known. In such a case, the one or more processes running on the voice-to-text services server could address the email to Jane from the voice-to-text services server with a reference to the originating phone number, for example, in the subject line. Alternatively, even if John does not register with the voice-to-text system, Jane could identify John and provide contact information for John (e.g. email address, phone number, blog address and/or social networking ID).

In the illustrated embodiment, Jane returns John's call and leaves a voice message 130. One or more processes running on the voice-to-text services server transcribe the voicemail 130 to an email 140 addressed to John. In the voicemail 130 and the email 140, Jane indicates that she doesn't feel well. One or more processes running on the voice-to-text services server recognize from the phrases “I have a leak” and “looking for a plumber” in John's transcribed message 120 that John needs a plumber and inserts an advertisement 142 and a coupon 144 for plumbing services in the reply email 140 to John. Alternatively, as soon as John leaves a voicemail 120 for Jane indicating he needs a plumber, the server could send John an unsolicited email (or unsolicited text message, blog post, etc.) including the advertisement 142 and the coupon 144, and possibly the transcribed text of the voice message he left for Jane. Alternatively, as soon as John leaves a voicemail 120 for Jane indicating he needs a plumber, the server could send one or more advertisers offering plumbing services a message comprising contact and profile information for John indicating that he may require plumbing services. The advertisers could then decide whether or not to contact John via, for example, email with a general or tailored service offering.

In the illustrated embodiment, one or more processes running on the voice-to-text services server recognize that Jane has left John a voicemail 130 that indicates she doesn't feel well, and send Jane an unsolicited text message 150 that lets Jane know that a walk-in clinic near Jane is offering a $20 discount for walk-ins. In the illustrated embodiment, the text message 150 is unsolicited, and is issued in response to the transcription of Jane's voicemail 130. In other embodiments, Jane is only notified of the walk-in clinic's promotion if she explicitly replies to the email 140 from the voice-to-text system or receives another transcribed voice message.

In the illustrated embodiment, the one or more processes running on the voice-to-text services server identify the advertisements 142, 144 and 150 by matching key phrases such as “looking for a plumber,” “leak in the basement” and “I don't feel well” to advertisement definitions set up by or on behalf of advertisers. Such advertisement definitions could specify additional parameters for selecting targeted users, such as geographic location, user demographic information and user preferences.

In one embodiment, the one or more processes running on the voice-to-text services server could charge the advertiser a fee every time an advertisement is sent to a user. In other embodiments, one or more processes running on the voice-to-text services server could support other monetization models. In one embodiment, the one or more processes running on the voice-to-text services server supports a pay-per-click model where, for example, an advertisement contains an embedded hyperlink, and the advertiser is charged every time a user clicks on the hyperlink. In one embodiment, one or more processes running on the voice-to-text services server supports a pay-per-action model where, for example, the advertiser is charged every time a user redeems a coupon or makes a purchase in response to an advertisement.

FIG. 2 shows an example of a high-level overview of a network supporting a voice-to-text system with targeted advertising. One or more users 210 subscribe to a voice network 220, which could include one or more of any type of voice networks now known or later to be implemented, such as a land based network, a cellular network or a satellite network. The users may additionally have Internet 230 access and may have one or more email addresses, maintain a blog, and/or may be members of a social networking or microblogging site.

A voicemail service provider 240 provides voice messaging services for subscribers of the voice network 220. In one embodiment, the voicemail service provider 240 is an entity that owns, supports or maintains the voice network 220. In one embodiment, the voicemail service provider 240 is a separate entity. In one embodiment, the voicemail service provider 240 has one or more voicemail services servers 241 and voicemail databases 242 to support voice messaging services. In one embodiment, the voicemail service provider 240 additionally provides voice-to-text services with targeted advertising. In one embodiment, the voicemail service provider 240 has one or more voice-to-text servers 244, voice-to-text databases 246 and advertisement databases 248 to support voice-to-text services with targeted advertising.

In one embodiment, the voice-to-text databases 246 include the data to convert voice messages to text. Such databases could include vocabulary databases and user profiles. In one embodiment, the advertisement databases 248 include targeted advertisements. In one embodiment, advertisers 260 submit definitions of advertisements to the voice-to-text servers via the Internet. In other embodiments, advertisers submit definitions of advertisements to the voicemail services provider 240 using any convenient medium, such as via a voice network 220, fax or hardcopy mail (not shown).

FIG. 3 shows a block diagram of a data processing system which can be used in various embodiments of the systems and methods disclosed herein. While FIG. 3 illustrates various components of a computer system, it is not intended to represent any particular architecture or manner of interconnecting the components. Other systems that have fewer or more components may also be used.

In FIG. 3, the system 301 includes an inter-connect 302 (e.g., bus and system core logic), which interconnects a microprocessor(s) 303 and memory 308. The microprocessor 303 is coupled to cache memory 304 in the example of FIG. 3.

The inter-connect 302 interconnects the microprocessor(s) 303 and the memory 308 together and also interconnects them to a display controller and display device 307 and to peripheral devices such as input/output (I/O) devices 305 through an input/output controller(s) 306. Typical I/O devices include mice, keyboards, modems, network interfaces, printers, scanners, video cameras and other devices which are well known in the art.

The inter-connect 302 may include one or more buses connected to one another through various bridges, controllers and/or adapters. In one embodiment the I/O controller 306 includes a USB (Universal Serial Bus) adapter for controlling USB peripherals, and/or an IEEE-1394 bus adapter for controlling IEEE-1394 peripherals.

The memory 308 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 3 is used to implement voice-to-text services servers 244 and/or voicemail services servers 241 of FIG. 2.

In one embodiment, a data processing system as illustrated in FIG. 3 is used to implement user devices, such as 212 of FIG. 2, which receive messages from voice-to-text services servers embodying transcribed voice messages and which may additionally include targeted advertisements. A user terminal may be in the form of a personal digital assistant (PDA), a cellular phone, a notebook computer or a personal desktop computer.

In some embodiments, one or more servers of the system can be replaced with the service of a peer to peer network of a plurality of data processing systems, or a network of distributed computing systems. The peer to peer network, or a distributed computing system, can be collectively viewed as a server data processing system.

Embodiments of the disclosure can be implemented via the microprocessor(s) 303 and/or the memory 308. For example, the functionalities described can be partially implemented via hardware logic in the microprocessor(s) 303 and partially using the instructions stored in the memory 308. Some embodiments are implemented using the microprocessor(s) 303 without additional instructions stored in the memory 308. Some embodiments are implemented using the instructions stored in the memory 308 for execution by one or more general purpose microprocessor(s) 303. Thus, the disclosure is not limited to a specific configuration of hardware and/or software.

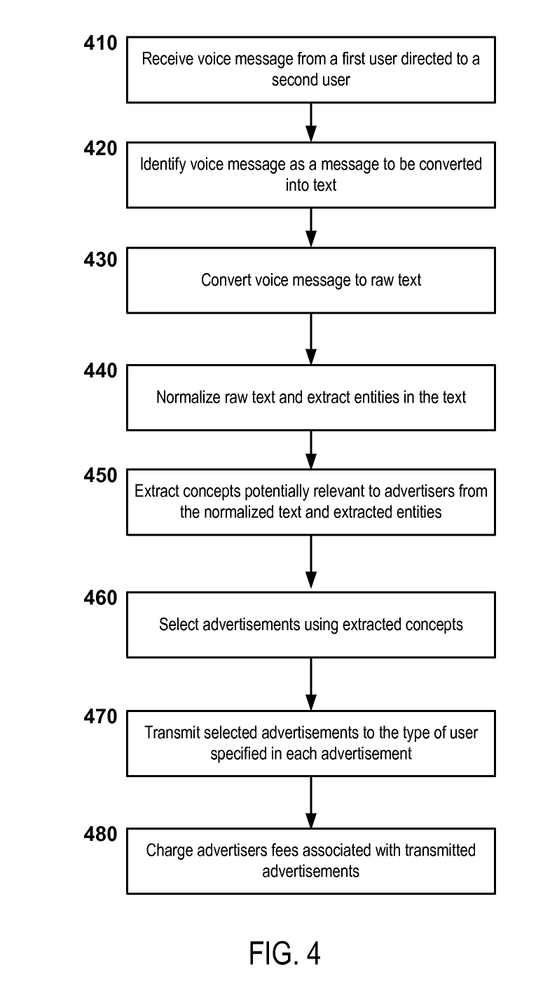

FIG. 4 shows a method that provides targeted advertisements in a voice-to-text system. In one embodiment, one or more conventional voicemail services servers such as are well known in the art provide voice messaging services used in the method. In one embodiment, one or more processes running on voicemail services servers, such as 241 of FIG. 2, provide such messaging services and store voice messages on one or more voicemail databases, such as 242 of FIG. 2.

In one embodiment, one or more processes running on voice-to-text services servers, such as 244 of FIG. 2, provide voice-to-text services including targeted advertising and store data relating to voice-to-text services and targeted advertising on one or more databases such as 246 and 248 of FIG. 2.

In the first operation of the method, a process running on a voicemail server receives a voice message 410 from a first user directed to a second user and stores the voice message in a voice message database. In one embodiment, the voice message is directed to one user, or alternatively, is directed to a group of users. For example, a voicemail could be for a natural person or an organization. An organization could include a plurality of users such as, for example, a customer support group or a sales group.

In the second operation of the method, a process running on a voice-to-text server identifies 420 the voice message for conversion to text. In one embodiment, the process running on the voice-to-text server identifies the voice message for conversion to text using a user profile associated with the second user (e.g. the recipient). Alternately, or additionally, the process running on the voice-to-text server identifies the voice message for conversion to text using a list of subscribers of voice-to-text services stored on a computer readable medium such as, for example, the voice-to-text databases 246 of FIG. 2. In one embodiment, the process running on the voice-to-text server only selects voice messages originating from specific phone numbers or a specific class of phone numbers. For example, a user profile could explicitly specify that the process transcribe specific phone numbers or specific persons. In another example, the process running on the voice-to-text server excludes voice messages from businesses. In one embodiment, the process running on the voice-to-text server excludes voicemails that represent hangups with no actual voice message.

In the third operation of the method, a process running on a voice-to-text server converts 430 the voice message to raw text. In one embodiment, a process running on a voice-to-text server converts voice messages to text using any conventional speech recognition technology now known or later to be developed. In one embodiment, voice-to-text databases include a large vocabulary for processing messages in a single language. In one embodiment, voice-to-text databases include a large vocabulary for processing messages in multiple languages (e.g. English, Spanish and French). In one embodiment, the raw text does not contain punctuation. In one embodiment, the raw text additionally includes information regarding the voice message, which could include the phone number of origin, a sender name associated with the phone number of origin, a date and a time. In one embodiment, a process running on a voice-to-text server identifies the sender's name using conventional caller ID technology and/or information about the originating phone number stored in a user profile for the user sending the voicemail and/or the user receiving the voicemail.

In the fourth operation of the method, a process running on a voice-to-text server normalizes the raw text 440. Normalization of raw text can include any set of transformations of the text designed to render the meaning of the text more readily apparent. In one embodiment, normalization of the raw text includes inserting punctuation into the text and the recognition and extraction of entities embodied in the text. In one embodiment, the text normalization process supports normalization for text in multiple languages (e.g. English, Spanish and French). In one embodiment, extracted entities could include persons, places, objects or businesses.

In one embodiment, a process running on a voice-to-text server normalizes the raw text using natural language processing techniques to insert punctuation into the text and extract entities embodied in the text. As referenced herein, natural language processing techniques could include any conventional natural language processing technique now known or later to be developed that is capable of normalizing raw text. Natural language understanding systems can convert samples of human language into formal representations, such as parse trees or first-order logic structures that are easier for computer programs to manipulate. In addition to inserting punctuation and extracting entities, natural language processing techniques can be used to segment individual words in text, disambiguate the meaning of words, account for regional accents or speech impediments, account for grammatical errors and differentiate between speech acts and planned acts.

In one embodiment, natural language processing techniques in this operation include statistical natural-language processing. Statistical natural-language techniques use stochastic, probabilistic and statistical methods for disambiguation of words. Such techniques can employ machine learning technology to apply quantitative approaches to automated language processing, including use of corpora and Markov models, probabilistic modeling, information theory, and linear algebra.

In the fifth operation of the method, a process running on a voice-to-text server extracts concepts 450 that are potentially relevant to advertisers from the normalized text and extracted entities. In one embodiment, concepts relevant to advertisers can include words, phrases, user context information and user profile information. In one embodiment, the process uses natural language processing techniques to identify relevant concepts in the normalized text and extracted entities, in particular statistical natural-language processing techniques that employ machine learning and parsing techniques to extract relevant concepts.

In one embodiment, the machine learning techniques in this operation include classifiers trained to recognize keywords and key phrases. For example, in one embodiment, the process running on a voice-to-text server extracts concepts using trained Support Vector Machines. SVMs are a set of related supervised learning methods used for classification and regression. Given a set of training examples, each marked as belonging to one of a set of categories, an SVM training algorithm builds a model that predicts whether a new example falls into a particular category. Other types of classifiers trained using supervised learning methods can include Bayesian classifiers, Parzen classifiers, Backpropagation classifiers such as neural networks, and classifiers with Principal Component Analysis.

In one embodiment, a process running on a voice-to-text server trains a classifier to recognize critical phrases using a training set of labeled phrases. In one embodiment, an off-line process is to label a set of data manually to identify “request phrases” for business information. Examples include “looking for a plumber,” “had a leak in,” “not feeling too well,” “plan to buy a car,” and so forth. In one embodiment, such phrases are critical phrases. In one embodiment, a process running on a voice-to-text server uses critical phrases to train a classifier that supports supervised machine learning, such as an SVM or any of the other types of classifiers discussed above.

Additional concepts relevant to advertisements could include brand names, such as “Honda” or “Coca Cola,” and product names, such as “iPad” and “Diet Coke.” In one embodiment, a process running on a voice-to-text server could train a classifier to recognize brands using manually labeled sets. In one embodiment, a database maintains brand names and product names. In one embodiment, the inclusion of brand names and product names in labeled training sets and/or a brand and product database is based on a specific request from an advertiser.

In one embodiment, the process additionally extracts user context information about the sending user and/or the receiving user. Broadly defined, user context includes a set of data that defines the user's current situation. Such data could include the user's current location and surroundings, and could additionally include the user's mental state as well, including the user's current mood and activities. The process could determine user context using a number of techniques. In one embodiment, the process imputes the location of a user based on the area code of the sending and/or receiving user or the sending and/or receiving user's profile. Additionally or alternatively, the process imputes the location of the sender and/or receiver based on the text of the message, for example, “I′m in New York” or “I know you are in San Jose.”

In the sixth operation of the method, a process running on a voice-to-text server selects advertisements that are relevant to the extracted concepts 460. In one embodiment, the process uses the extracted concepts to search through an inventory of ad-based and/or coupon-based advertisements stored on a advertisement database. Advertisements could include any combination of text and/or graphics that are capable of electronic communication. For example, such advertisements could include ad text, images of products, coupons, web links which could include online coupon or offer codes, and so forth. In one embodiment, advertisements could specify alternate forms depending on the mode of delivery. For example, an advertisement via email could contain elaborate graphics, whereas an advertisement via text message could be a short text message.

In one embodiment, the process selects advertisements by matching extracted concepts to user selection criteria associated with the advertisements. User selection criteria could include one or more critical phrases, entity names, and/or user context information. Thus, for example, a plumber could place an advertisement for the phrases “looking for a plumber” and “had a leak in,” a walk-in clinic could place an advertisement for “not feeling too well,” and a car dealer could place an advertisement for “plan to buy a car.” Such advertisements could additionally be qualified by entity names, such as a specific company, for example, “Honda,” “Toyota” or “Ford.” Such advertisements could additionally be qualified by user context information, such as a specific location, for example “looking for a plumber” in the 212 area code or “not feeling too well” in the 34567 zip code, a specific date or time range, a mood such as “sad” or “happy,” or an activity such as “working,” “on vacation” or “at a concert.”

The above examples are purely illustrative, and it is understood that advertisement user selection criteria could include any number and combination of concepts that could exist in any logical relationship with one another. Thus, an advertisement could have user selection criteria that include a list of five concepts that are all required. Alternatively, user selection criteria could be a list of five concepts where only one of the five needs to be matched. Additionally, the process could provide for excluding specific concepts. For example, while “I need a new car” might match an advertisement, the advertiser might not wish to send advertisements to a user who additionally says “I can't afford one” or “I′m filing for bankruptcy.”

Additionally, user selection criteria could additionally or alternatively include user profile information. For example, an advertiser may wish to direct a specific advertisement to a specific demographic group, such as an age range or marital status. The advertiser may wish to direct an advertisement to users that explicitly state an interest in the advertiser's products or, possibly, who state an interest in a competitor's products. The advertiser may wish to direct an advertisement to users that explicitly state an interest in a general subject area, such as cooking or traveling. In one embodiment, a service provider who receives requests for advertisements from advertisers maintains the advertisement database. In one embodiment, the service provider provides an online advertisement entry function whereby advertisers can register with the service, define advertisements, and upload graphics and other media assets (e.g. audio or video files) for advertisement copy. In one embodiment, any number of advertisers can place advertisements for the same concepts or a combination of concepts. In one embodiment, advertisers competitively bid for specific concepts or a combination of concepts.

In one embodiment, the process described above identifies advertisements that are relevant to the voicemail sender, for example, “I need a plumber” clearly indicates the sender needs a plumber. In one embodiment, the process may also be able to identify advertisements that are or may be relevant to the recipient, for example, “you need a new car” may indicate the recipient needs a new car. The sender's intent will typically be easier to determine than attempting to impute the recipient's state of mind from the message of another, nevertheless, an advertiser may still be interested in directing advertisements to users who receive a specific phrase in a message and fit additional criteria such as, for example, specific demographic criteria. In one embodiment, the process may additionally or alternatively identify advertisements that are or may be relevant to both the sender and the recipient. For example, the phrase “did you see the new ‘iPad’” may imply that the sender and the recipient talk about electronic devices occasionally or frequently, and thus both may have an interest in such devices.

Thus, in one embodiment, user selection criteria associated with advertisements on an advertising database can specify whether a concept, a combination of concepts and/or user profile information select advertisements to be directed to a voicemail sender, a voicemail recipient, or both.

In the seventh operation of the method, a process running on a voice-to-text server transmits the selected advertisements 470 to the type of user specified in each advertisement. In one embodiment, advertisements can be sent to voicemail senders (e.g. the first user), voicemail recipients (e.g. the second user), or both. The advertisement can be sent in any electronic form that is suitable for delivery to the receiving user. Such formats could include emails, text messages, blog posts, microblog posts (e.g. Twitter) and messages on social networking sites (e.g. Facebook). In one embodiment, the advertisement could be sent to the receiving user in more than one form, for example as an email and as a text message. The content of the advertisement could be tuned to the form; for example, emails could contain graphics, while text messages only include a short text message.

In one embodiment, the process running on a voice-to-text server transmits unsolicited messages containing the advertisements to the specified users as soon as one or more advertisements are selected, such as, for example, unsolicited text message 150 of FIG. 1 above. In one embodiment, the process only inserts advertisements messages containing transcribed voice messages such as, for example, 140 above. When an advertisement is directed to a message recipient, the process can simply insert the advertisement into the transcribed message sent to the recipient. When an advertisement is directed to a message sender, the process can use at least one of two possible approaches. In the first approach, the process inserts the selected advertisements the next voice-to-text message sent to the message sender, such as is shown in the example in 140 of FIG. 1. In the second approach, the process automatically sends the message sender a copy of the transcribed message and embeds selected advertisements into the message (not shown in FIG. 1).

In one embodiment, an advertisement can additionally or alternatively provide for notification of the advertiser associated with the advertisement. In one such embodiment, upon selection of such an advertisement, the process running on a voice-to-text server transmits a notification to the advertiser. In one embodiment, the notification can comprise contact and profile information for the message sender and/or the message recipient and an identification of the matched advertisement.

In the seventh operation of the method, a process running on a voice-to-text server charges advertisers associated with selected advertisement fees 480 for advertisements that have been sent to users. Any advertising fee models now know, or later to be developed could be used. For example, in one embodiment, the process charges an advertiser a transaction fee every time an advertisement is sent. In various other embodiments, the process charges advertisers every time a user takes a specific action, such as clicking on a web link, or redeeming a coupon or promotion code.

While the above described systems and methods are principally directed to embodiments incorporating transcription of voice messages to text, there are other possible embodiments that do not require translation of voice messages to text. For example, in one embodiment, the acoustic signals of voice messages are matched to advertisements without any conversions or translations. In one such embodiment could employ classifiers trained to recognize patterns in acoustic signals that correspond to critical phrases. In one such embodiment could additionally or alternatively employ classifiers trained to recognize patterns in acoustic signals that correspond to moods or emotions. Thus, transcription of voice messages could be an optional part of a system for matching advertisements to voice messages.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions, or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media, such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software, nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof

In the foregoing specification, the disclosure has been described with reference to specific exemplary embodiments thereof It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
receiving a voice message from a first user directed to a second user;
identifying, using a computing device, the voice message as a message to be converted into text;
converting, using the computing device, the voice message to a raw text message;
normalizing, using the computing device, the raw text message, producing a normalized text message;
extracting, using the computing device, concepts from the normalized text message;
selecting, using the computing device, advertisements placed by advertisers having user selection criteria that match the concepts;
transmitting the advertisements to the first user; and
charging, using the computing device, the advertisers for the advertisements transmitted to the first user.

2. The method of claim 1, wherein the concepts comprise critical phrases.

3. The method of claim 2, wherein the concepts additionally comprise user context information for the first user.

4. The method of claim 3, wherein the concepts additionally comprise user profile information for the first user.

5. The method of claim 1, wherein normalizing the raw text comprises adding punctuation to the raw text.

6. The method of claim 5, wherein the raw text is normalized using natural language processing techniques.

7. The method of claim 6, wherein the natural language processing techniques comprise a statistical natural-language processing technique.

8. The method of claim 1, wherein the concepts are extracted using natural language processing techniques.

9. The method of claim 8, wherein the natural language processing techniques comprise a statistical natural-language processing technique employing machine learning.

10. The method of claim 9, wherein the statistical natural-language processing technique employing machine learning comprises a classifier.

11. The method of claim 10, wherein the classifier is trained using a set of labeled critical phrases, each phrase labeled with at least one concept.

12. The method of claim 11, wherein the classifier is selected from the list: SVM, Bayesian classifier, Parzen classifier, Backpropagation classifier, neural network, and Principal Component Analysis.

13. The method of claim 1, wherein advertisers are charged a transaction fee for every advertisement transmitted to the first user.

14. The method of claim 1, wherein advertisers are charged a transaction fee when the first user takes an action with respect to an advertisement.

15. The method of claim 1 wherein the advertisements are not transmitted to the first user and a notification of a match is transmitted to the advertisers that placed the advertisements, the notification of a match comprising contact information for the first user.

16. The method of claim 15 wherein the notification of a match comprises contact information for the second user.

17. The method of claim 1 wherein the converting, normalizing, and extracting steps are not performed and advertisements having user selection criteria comprising patterns in acoustic signals that match at least a portion of the voice message are selected.

18. The method of claim 18 wherein the user selection criteria comprise a classifier trained to recognize critical phrases.

19. A computer system comprising:
a memory; and
at least one processor coupled to the memory to:
receive a voice message from a first user directed to a second user;
identify the voice message as a message to be converted into text;
convert the voice message to a raw text message;
normalize the raw text message, producing a normalized text message;
extract concepts from the normalized text message;
select advertisements placed by advertisers having user selection criteria that match the concepts;
transmit the advertisements to the first user; and
charge the advertisers for the advertisements transmitted to the first user.

20. A machine readable media embodying instructions, the instructions causing a data processing system to perform a method, the method comprising:
receiving a voice message from a first user directed to a second user;
identifying, using a computing device, the voice message as a message to be converted into text;
converting, using the computing device, the voice message to a raw text message;
normalizing, using the computing device, the raw text message, producing a normalized text message;
extracting, using the computing device, concepts from the normalized text message;
selecting, using the computing device, advertisements placed by advertisers having user selection criteria that match the concepts;
transmitting the advertisements to the first user; and
charging, using the computing device, the advertisers for the advertisements transmitted to the first user.
